(19) United States
(12) Patent Application Publication
(10) Pub. No.: US 2019/0004625 A1
(43) Pub. Date: Jan. 3, 2019

(54) TOUCH DEVICE

(71) Applicant: Hewlett-Packard Development Company ,L.P., Houston, TX (US)

(72) Inventor: Shan-Chih CHEN, Taipei (TW)

(73) Assignee: Hewlett-Packard Development Company ,L.P., Houston, TX (US)

(21) Appl. No.: 15/748,614

(22) PCT Filed: Oct. 29, 2015
(86) PCT No.: PCT/CN2015/093174

§ 371 Date: Jan. 29, 2018

(51) Int. Cl. G06F 3/044; G06F 3/041

(52) U.S. Cl. CPC G06F 3/044; G06F 3/0416; G06F 2203/04107; G06F 3/0414; G06F 3/0412

(57) ABSTRACT

A device is disclosed. The touch device comprises a first detection unit, a second detection unit and a control unit. The first detection unit is to generate first information indicating a position of a touch in response to the touch. The second detection unit disposed beneath the first detection unit is to generate second information indicating a measurement of the touch in response to the touch. The control unit coupled to the first and second detection units is to associate the first information and the second information. The generation of the first information is insulated from the generation of the second information.

### BACKGROUND

A touch device is a device used to sense whether a touch occurs, and perform a corresponding operation based in response to the touch. The touch device detects the position of an object (e.g. a finger or a stylus) applied to an input area of its touch screen/panel, in which touch sensors are arranged. Such sensors include conductive elements that overlap the input area. Touch sensors that can be used in the touch device include capacitive sensors, resistive sensors, and infrared sensors.

### BRIEF DESCRIPTION OF THE DRAWINGS

FIG. 1 depicts a schematic of a touch device in a touch operation according to an example;

FIG. 2A depicts a stack structure of a touch device according to an example;

FIG. 2B depicts a pattern design of a first sub-patterned layer according to an example;

FIG. 3A depicts a stack structure of a touch device according to another example;

FIG. 3B depicts a pattern design of a second sub-patterned layer according to an example;

FIG. 3C depicts a pattern design of a third sub-patterned layer according to an example;

FIG. 4 depicts a stack structure of a touch device according to another example;

FIG. 5 depicts an architecture of a touch device according to an example;

FIG. 6 depicts a method for detecting a pressure of a touch according to an example.

### DETAILED DESCRIPTION

In the following description of examples, reference is made to the accompanying drawing in which it is shown by way of illustration specific examples that can be practiced. It is to be understood that other examples can be used and structural changes can be made without departing from the scope of the various examples.

An example touch device is used to capture an external touch by monitoring the touch sensors' output. For example, a capacitive sensor may be used to detect a capacitance variation caused by the touch. The example provided herein can be used to detect a measurement of the touch on the touch device, such as a temperature or humidity, a pressure of the touch, an approximate position of the touch. In one example, the touch device may be a thermometer, a hygrometer, a mobile phone, a wearable electronic device, a health monitoring device, a surrounding monitoring device, a tablet computing device, a computer display, a computing input device (such as a touch pad, keyboard or mouse), a touch pad or screen, a button, and so on.

In some cases, a transparent or non-transparent touch-sensitive film is integrated with a non-display component to form a touch sensitive surface on the surface of an enclosure or other surface of the device. In some examples, the touch-sensitive film is integrated with a touch pad, touch panel or other touch-sensitive surface of a device. In one example, the touch-sensitive film is integrated with a touch pad of a notepad computer system. A touch may be sensed on a display, enclosure, or other surface of an electronic device using a touch sensor which can determine a measurement of the touch. The estimated magnitude or degree of the force may be used as an input signal or input data to the touch device. The permittivity of a capacitor is related to a temperature, thus, when the measurement detected by a capacitive touch-sensitive film is a temperature change of a stylus, the touch-sensitive film may generate an output quantity, such as a capacitance variation, to indicate the temperature change. To describe the present invention's the conception in more detail, a touch pressure described below is taken as an example of the measurement.

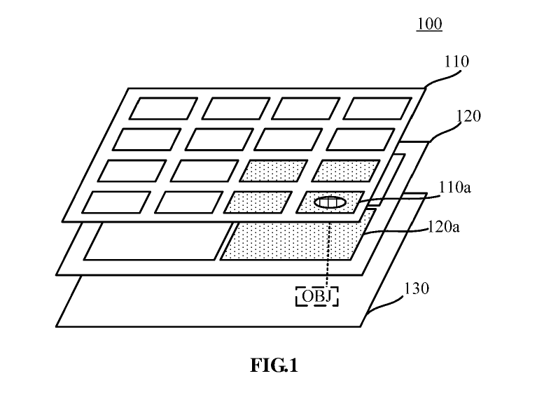

FIG. 1 depicts a schematic of a touch device in a touch operation according to an example. In this example, a touch device 100 may include a display element 130 disposed beneath a second detection layer 120 that is disposed beneath a first detection layer 110. The display element 130 may be generally referred to as a display and used to present visual content to the user of the touch device 100. The display element 130 may include a variety of devices, such as a liquid-crystal display (LCD), a light-emitting diode (LED) display, an organic light-emitting diode (OLED) display, or the like. As explained in more detail below, the first and second detection layers 110 and 120 may be transparent, and may be non-transparent in some cases. The detection layers 110 and 120 may be attached with each other via a space layer, for example, a pressure sensitive adhesive layers, a plastic layer, a glass layer, or other materials.

In an example operation that a user wants to select an object “OBJ” presented on the display element 130, he may touch an area directed to the position of the “OBJ”, such as block 110a, with a pressure. When the mentioned touch is implemented, the status of the block 110a is changed, and first information to indicate the position of the touch is generated, for example, the location of the block 110a. At the same time, the status of the block 120a disposed beneath the block 110a is also changed in response to the touch, and second information to indicate the pressure of the touch is generated. When a control unit coupled to the two layers obtains the information, it may associate the two information by establishing a relationship between the position and pressure of the touch.

In this example, the block 120a may have a larger detectable quality than the block 110a, which is shown by different size of the two blocks, to ensure the pressure of the touch can be sensed with an accuracy. And, the four blocks with black dots, located at lower right corner, correspond to the block 120a.

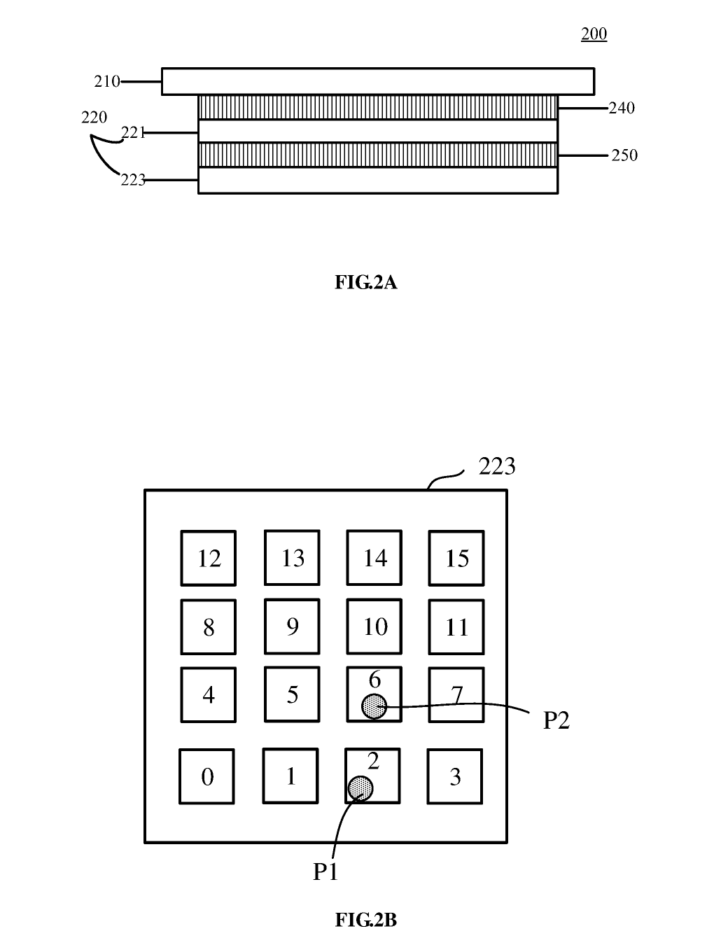

FIG. 2A depicts a stack structure of a touch device according to an example. An example stack 200 includes, without limitation, a first detection layer 210, a second detection layer 220, and wherein the second detection layer 220 includes a sub-shielding layer 221 and a first sub-patterned layer 223. The first detection layer 210 is attached to the second detection layer 220 by a first OCA (Optical clear adhesive) layer 240, and the sub-shielding layer 221 is attached to the first sub-patterned layer 223 by a second OCA layer 250. In some cases, the touch device 200 may comprise a display element on which the second detection layer 220 is attached by a third OCA layer. As discussed above, the display element may include, for example, an LCD display, an LED display, an OLED display, or the like. In some cases, the second detection layer 220 may be attached directly to the display element. However, in other examples, there may be additional components or layers between the display element and the second detection layer 220.

In this example, the substrate of the sub-shielding layer 221 is a transparent plastic or glass material with transparent full conductive material on it, such as Indium Tin Oxide (ITO), metal mesh, AG nano wire, carbon nano tube and etc. Regarding the first sub-patterned layer 223, its substrate may be made of a transparent plastic or glass material with a transparent patterned conductive material, such as ITO wires, metal meshes, AG nano wires, carbon nano tubes and etc.

FIG. 2B depicts a pattern design of a first sub-patterned layer according to an example. The pattern design can be, but not limited to, a matrix with the same size patterns. The shape of the patterned conductive material is not fixed, and it may be shaped as a square, a rectangle, a circle, a triangle, a rhombus or other forms. In such an example, the conductive material blocks of the first sub-patterned layer are electrically coupled to the control unit (the example connecting wires are not shown), and form an array of second detection capacitors with the first sub-pattern layer 223. The capacitance of each second detection capacitor can be increased by decreasing a distance between the sub-shielding layer 221 and the first sub-patterned layer 223. As described above, a detectable capacitance variation of each the first detection capacitor may be less than a detectable capacitance variation of each the second detection capacitor.

By this configuration, the first detection layer 210 can comprise an array of first detection capacitors to detect a touch to generate first capacitance variation information corresponding to each of the first detection capacitors; while the second detection layer 220 can comprise an array of second detection capacitors formed by the sub-shielding layer 221 and the first sub-patterned layer 223, and is disposed beneath the first detection layer 210 to detect the touch to generate second capacitance variation information corresponding to each of the second detection capacitors in response to the touch. In an operation that a touch is applied to the touch device, a capacitance at a specific detection capacitor in the array that corresponds to the touch position is changed by the touch, and the control unit can obtain first capacitance variation information correspondingly. Meanwhile, the control unit can also obtain second capacitance variation information in response to the touch.

In some cases, the control unit may obtain capacitance variation information including a Point ID and a coordinate of the capacitor. In some other cases, the capacitance variation information may include a status indicator to indicate whether the capacitor P1 is directly or in directly touched. In an example multi-touch operation, there are more than two touch points. The control unit can obtain a number of indicating parameters about the touch point based on the first capacitance variation information, which indicates there are two touch points and coordinate thereof, as shown in table 1.

TABLE 1
Position Information

| Point ID | Coordinate (X) | Coordinate (Y) |
|---|---|---|
| P1 | 220 | 80 |
| P2 | 240 | 150 |

In an example that the second detection layer comprises 16 (4×4) second capacitors, the control unit can obtain 16 pressure data as shown in table 2.

TABLE 2
Pressure Information

| Cap ID | CAP | Cap ID | CAP | Cap ID | CAP | Cap ID | CAP |
|---|---|---|---|---|---|---|---|
| 12 | 6 | 13 | 12 | 14 | 21 | 15 | 0 |
| 8 | 0 | 9 | 12 | 10 | 5 | 11 | 6 |
| 4 | 35 | 5 | 0 | 6 | 145 | 7 | 30 |
| 0 | 0 | 1 | 10 | 2 | 230 | 3 | 120 |

Based on the coordinate (220, 80), Point 1 is found in the area of Cap 2 after comparing the position between the first and second detection layers. Then the capacitance variation of capacitor 2, which is determined as a pressure data, is associated with the point 1. In a same way, the point 2 corresponds to the capacitor 6. Finally, the control unit can obtain information indicating a position and pressure of the touch, as shown in table 3. In table 3, the data in column Z is added, which is obtained by the capacitors 2 and 6 to indicate the touch pressure.

TABLE 3
Associated Information

| Point ID | X | Y | Z |
|---|---|---|---|
| 1 | 220 | 80 | 230 |
| 2 | 240 | 150 | 145 |

In an example, the control unit may send the associated information to a host through an interface, for example, an I2C interface, a USB interface, a UART or other communicative interfaces. Then the host can use the pressure data to perform corresponding operations. In an example, the control unit may directly use the pressure to perform corresponding operations.

In such an example, the sub-shielding layer 221 may be coupled to a fixed voltage, such as 0V (i.e. the ground), 3V, 5V or other permitted voltages, to form a polar plate of the second detection capacitors and insulate the generation of the first capacitance variation information from that of the second capacitance variation information. Also, the sub-shielding layer 221 may prevent the first detection layer 210 from a noise generated by the display elements.

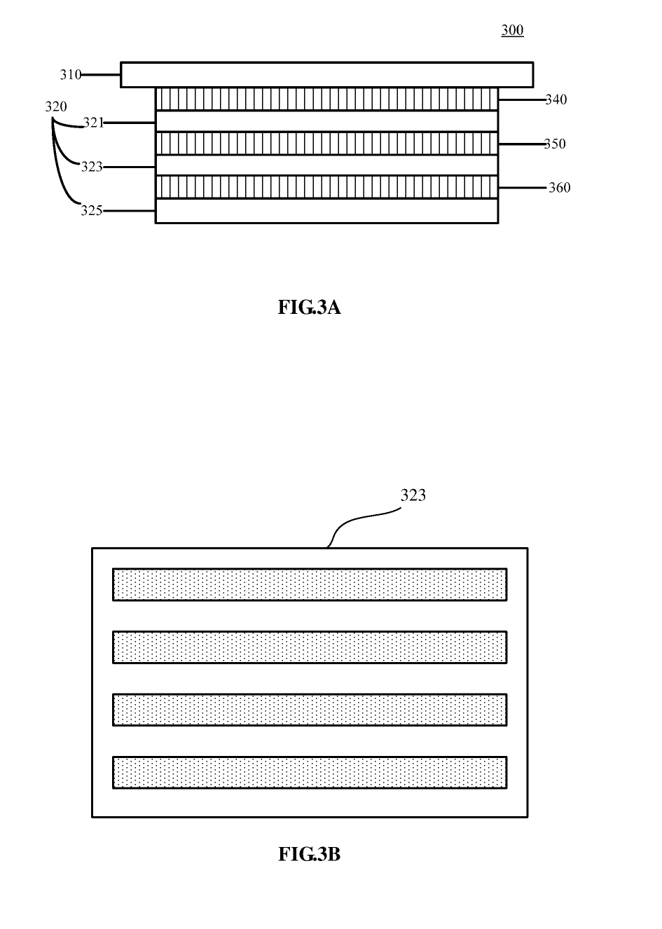

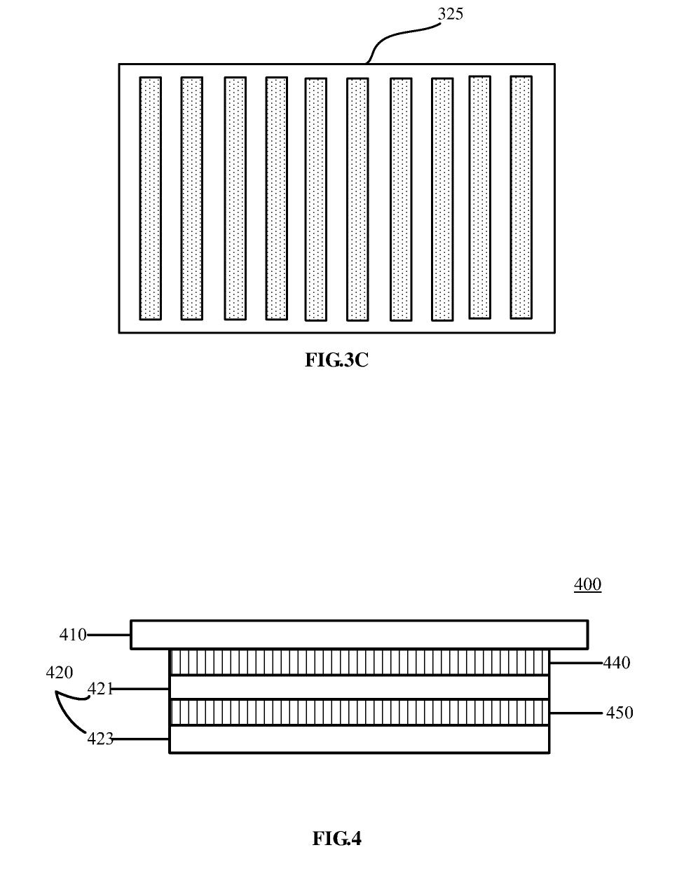

FIG. 3A depicts a stack structure of a touch device according to another example. The example touch device 300 may also comprise a first detection layer 310 to provide an information indicating a position of the touch, and a second detection layer 320 to provide an information indicating a pressure of the touch.

In such an example, the second detection layer 320 is disposed between the first detection layer 310. Based on the example stack, there are five parts in the second detection layer 320, i.e. the sub-shielding layer 321, the second sub-patterned layer 323, the third sub-patterned layer 325 and two OCA (Optical clear adhesive) layers 350 and 360. The first detection layer 310 is attached to the second detection layer 320 by an OCA layer 340. In some cases, the touch device 300 may comprise a display element on which the second detection layer 320 is attached by an OCA layer.

The substrate of the sub-shielding layer 321 may also be a transparent plastic or glass material with transparent full conductive material on it. Regarding the second and third sub-patterned layers 323 and 325, their substrates may be made of a transparent plastic or glass material with a transparent patterned conductive material. The second and third sub-patterned layers 323 and 325 connect to a control unit (not shown) for detecting a capacitance variation.

FIG. 3B depicts a pattern design of a second sub-patterned layer according to an example, and FIG. 3C depicts a pattern design of a third sub-patterned layer according to an example.

In this example, the second sub-patterned layer 323 disposed beneath the sub-shielding layer has an array of conductive material bars distributed along a first direction, and the third sub-patterned layer 325 disposed beneath the second sub-patterned layer 323 has an array of conductive material bars distributed along a second direction orthogonal to the first direction. As shown in FIGS. 3B and 3C, the first direction is axial, and the second direction is longitudinal. In another example, the first direction may be longitudinal, and the second direction is axial. By this configuration, the array of the second detection capacitors are formed by the second and third sub-patterned layers 323 and 325, and located at intersections of the bars of the two layers. Similarly, as described in FIG. 2B, a detectable capacitance variation of each the first detection capacitor is less than a detectable capacitance variation of each the second detection capacitor.

In this example, the sub-shielding layer 321 is coupled to a fixed voltage, such as 0V (i.e. the ground), 3V, 5V or other permitted voltages. Due to the existence of the sub-shielding layer, the second sub-patterned layers 323 can be implemented as either a Tx layer which is coupled to an excitation signal or a Rx layer which is to receive signals from the Tx layer, and the signal transmission between the two sub-patterned layers can not be disturbed by the operation of the first detection layer 310.

FIG. 4 depicts another stack structure of a touch device according to an example. The touch device 400 may also comprise a first detection layer 410 to provide information indicating a position of the touch, and a second detection layer 420 to provide an information indicating a pressure of the touch.

In an example, the second detection layer 420 is disposed between the first detection layer 410 and the display element. Based on the stack, there are three parts in the second detection layer 420, i.e. a sub-shielding layer 421, a fourth sub-patterned layer 423, and an OCA layers 450. The substrate of the sub-shielding layer 421 and the fourth sub-patterned layer 423 may also be made of transparent plastic or glass material with transparent conductive material. The first detection layer 410 is attached to the second detection layer 420 by an OCA layer 440. In some cases, the touch device 400 may comprise a display element on which the second detection layer 420 is attached by an OCA layer.

In this example, the sub-shielding layer 421 includes an array of conductive material bars distributed along a first direction, and the fourth sub-patterned layer 423 disposed beneath the sub-shielding layer 421 includes an array of conductive material bars distributed along a second direction orthogonal to the first direction. By this configuration, the array of the second detection capacitors are formed by the sub-shielding layer 421 and the fourth sub-patterned layer 423, and located at intersections of the bars of the two layers. Similarly, as described above, a detectable capacitance variation of each the second detection capacitor may be less than a detectable capacitance variation of each the second detection capacitor.

In this example, the sub-shielding layer 421 is coupled to an excitation signal to function as a Tx layer, while the fourth sub-patterned layer functions as an Rx layer. When the control unit scans the bars on the Tx layer one by one, the sub-shielding layer 421 can also substantially insulate the information generations implemented by the two layers 421 and 423. In particular, when a bar on the Tx layer is used to transmit the excitation signal, other bars are coupled to a fixed voltage, such as 0V (i.e. the ground), 3V, 5V or other permitted voltages. Thus, sub-shielding layer 421 can functions as a shield, and the signal transmission between the layers 421 and 423 can not be disturbed by the operation of the first detection layer 410. Also, the sub-shielding layer 421 may prevent the first detection layer 410 from a noise generated by the display elements.

FIG. 5 depicts an architecture of a touch device according to an example. The touch device 500 comprises, without limitation, a first detection unit 510, a second detection unit 520, and a control unit 530. The first detection unit 510 is communicatively coupled to the control unit 530, and is used to generate first information indicating a position of a touch in response to the touch. The second detection unit 520 disposed beneath the first detection unit 510 is electrically coupled to the control unit 530, and is used to generate second information indicating a pressure of a touch in response to the touch. Thus, the control unit 530 can obtain both the first and second information which can describe different parameters indicating the touch.

When a touch is applied on the touch device, both the two detection units 510 and 520 can generate a capacitance variation information. The example control unit 530 is electrically coupled to both the first and second detection units 510 and 520, and obtains the different capacitance variation information from the two detection units. After analyzing the capacitance variation information, the control unit 530 can associate the position obtained from the first information with a pressure obtained from the second information based on a positional correspondence relationship between the two detection units. In other words, the control unit 530 assigns the pressure data into a current or corresponding touch position. After associating the first information and the second information, the control unit can obtain information indicating the position and the pressure of the touch, based on which the control unit 530 may trigger a corresponding behavior. In a case that the control unit 530 is coupled to a host, it may transmit the information including the position and the pressure of the touch to the host via an interface, such as a SPI, an I2C, a UART or other communicative interfaces. Then, the host may perform a corresponding operation.

In some cases, the touch device 500 may comprise a feedback unit which is communicatively coupled to the control unit 530 to generate a notification when the obtained pressure of the touch is greater than a predetermined threshold. After obtaining the notification, the control unit 530 or the host coupled to the control unit 530 may trigger an operation that notifies the user a pressure of the current touch is too large. The triggered operation may be a visual presence, a sound, a vibration or other sensible operations.

As described above, the example first detection unit 510 comprises an array of first detection blocks, such as the block 110a, for generating the first information, and an example second detection unit 520 comprises an array of second detection blocks, such as the block 120a, for generating the second information. In this configuration, the position of the block 110a is directed to the position of the blocks 120a.

When a touch is applied to the touch device, for example, a touch point is located in the block 110a, the first detection unit 510 can detect that a capacitance variation occurs at the block 110a, and the coordinate of the touch point can be determined based on the first information. In response to a same touch, a capacitance variation also occurs at the block 120a, and the pressure indicated by the second information is determined based on the capacitance variation detected by the block 2a. In this configuration, a detectable capacitance variation of each the first detection block (eg. the block 110a) is less than a detectable capacitance variation of each the second detection block (eg. the block 120a).

An example second detection unit 520 may comprise a shield to insulate the generation of the first information from the generation of the second information, thus, the interferences between the two detection layers is reduced. The example shield may be implemented by coupling to a fixed voltage or other permitted voltages, even an excitation signal.

An example touch device 500 may comprise a display unit (not shown) in which a user intends to select an object presented by the display unit to trigger an operation. In this example, the display unit disposed beneath the second detection unit 520 can mechanically support the second detection unit 520 and provide visual contents. By this configuration, an additional support element for supporting the stack including the first and second detection units 510 and 520 can be reduced.

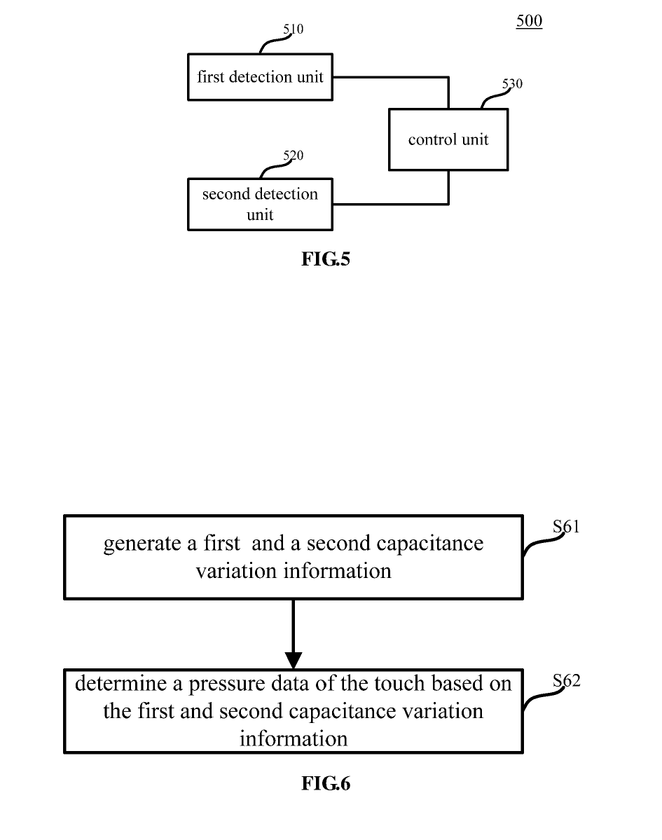

FIG. 6 depicts a method for detecting a pressure of a touch according to an example. In this example, the touch is detected by a first and a second detection layers.

At block S61, the first and the second detection layers respectively generates first capacitance variation information and second capacitance variation information in response to a touch. The first capacitance variation information is to indicate a position of the touch, and the second capacitance variation information is to indicate a pressure of the touch.

At block S62, a pressure data of the touch is determined based on the first capacitance variation information and the second capacitance variation information. For details, a capacitance variation corresponding to a position of the touch is obtained from the second capacitance variation information. The information is compared based on a positional correspondence of the two layers to determine which capacitance variation generated by the second detection layer is directed to the position of the touch indicated by the first detection layer. And, the capacitance variation corresponding to the position of the touch is determined as the pressure date.

The method may further comprise comparing the pressure data with an example predetermined threshold, and generating a notification when the pressure data is greater than the predetermined threshold. The pressure data and the predetermined threshold used herein may be a capacitance variation, strength of a touch calculated by the capacitance variation, or other comparable value.

The foregoing disclosure describes a number of examples for detecting a touch. It should be appreciated the described examples intend to illustrate rather than limit the scope of the disclosure. Thus the claims are not intended to be limited to the illustrated details of the examples, but are to be accorded the full scope consistent with the language of the claims.

1. A touch device, comprising:
a first detection unit to generate first information indicating a position of a touch in response to the touch;
a second detection unit, disposed beneath the first detection unit, to generate second information indicating a measurement of the touch in response to the touch;
a control unit, coupled to the first and second detection units, to associate the first information and the second information,
wherein the generation of the first information is insulated from the generation of the second information.

2. The touch device of claim 1, wherein the second detection unit comprises a shield to insulate the generation of the first information from the generation of the second information.

3. The touch device of claim 1, wherein
the first detection unit comprises an array of first detection blocks for generating the first information, the second detection unit comprises an array of second detection blocks for generating the second information,
wherein a detectable capacitance variation of each the first detection block is less than a detectable capacitance variation of each the second detection block.

4. The touch device of claim 3, wherein the control unit is to associate the measurement of the touch with the position of the touch based on a positional correspondence relationship between the first and the second detection blocks.

5. The touch device of claim 1, wherein the measurement of the touch comprises at least one of:
a pressure;
a temperature;
a humidity; and
a position.

6. The touch device of claim 1, further comprising:
a display unit, disposed beneath the second detection unit and mechanically supporting the second detection unit, to provide visual contents.

7. A method for detecting a pressure of a touch in a touch device, comprising:
generating, by a first detection layer and a second detection layer, first capacitance variation information and second capacitance variation information respectively, in response to a touch; and
determining a pressure data of the touch based on the first capacitance variation information and the second capacitance variation information,
wherein the generation of the first capacitance variation information is insulated from the generation of the second capacitance variation information.

8. The method of claim 7, the determining further comprising:
obtaining a capacitance variation corresponding to a position of the touch from the second capacitance variation information; and
determining the capacitance variation as the pressure data.

9. The method of claim 8, further comprising:
comparing the pressure data with a predetermined threshold; and
generating a notification when the pressure data is greater than the predetermined threshold.

10. A touch device, comprising:
a first detection layer, comprising an array of first detection capacitors, to detect a touch to generate first capacitance variation information corresponding to each of the first detection capacitors; and
a second detection layer, comprising an array of second detection capacitors, disposed beneath the first detection layer, to detect the touch to generate second capacitance variation information corresponding to each of the second detection capacitors,
wherein the second detection layer comprises a sub-shielding layer to insulate the generation of the first capacitance variation information and the generation of the second capacitance variation information.

11. The touch device of claim 10, wherein
the sub-shielding layer is coupled to a fixed voltage;
the second detection layer further comprises:
a first sub-patterned layer, disposed beneath the sub-shielding layer, having an array of conductive material blocks; and
the array of the second detection capacitors are formed by the sub-shielding layer and the first sub-patterned layer.

12. The touch device of claim 10, wherein
the sub-shielding layer is coupled to a fixed voltage;
the second detection layer further comprises:
a second sub-patterned layer, disposed beneath the sub-shielding layer, having an array of conductive material bars distributed along a first direction; and
a third sub-patterned layer, disposed beneath the second sub-patterned layer, having an array of conductive material bars distributed along a second direction orthogonal to the first direction; and
the array of the second detection capacitors are formed by the second sub-patterned layer and the third sub-patterned layer.

13. The touch device of claim 10, wherein
the sub-shielding layer includes an array of conductive material bars distributed along a first direction;
the touch module further comprises:
a fourth sub-patterned layer, disposed beneath the sub-shielding layer, having an array of conductive material bars distributed along a second direction orthogonal to the first direction; and
the array of the second detection capacitors are formed by the s the sub-shielding layer and the fourth sub-patterned layer, and the sub-shielding layer is coupled to an excitation signal.

14. The touch device of claim 10, wherein a detectable capacitance variation of each the first detection capacitor is less than a detectable capacitance variation of each the second detection capacitor.

15. The touch device of claim 10, further comprising:
a control unit, coupled to the first and the second detection layers, to obtain position information of the touch from the first capacitance variation information, and to obtain pressure information of the touch from the second capacitance variation information.
